(19) United States
(12) Patent Application Publication
(10) Pub. No.: US 2005/0091854 A1
(43) Pub. Date: May 5, 2005

(54) Apparatus and methods for providing oral tactile stimulation while delivering food

(76) Inventor: Lori Ann Johnson, West Bend, WI (US)

Correspondence Address: RYAN KROMHOLZ & MANION, S.C., POST OFFICE BOX 26618, MILWAUKEE, WI, 53226, US

(21) Appl. No.: 10/696,218

(22) Filed: Oct. 29, 2003

(51) Int. Cl. A47J 43/28

(52) U.S. Cl. 30/324; 30/322

(57) ABSTRACT

A transitional feeding tool for individuals with oral sensory problems comprises a handle and a food-carrying platform carried by the handle. The food-carrying platform has a top surface and a bottom surface extending along an axis and at least one blunt projection extending radially from the bottom surface of the platform. The projection is adapted to contact the tongue to provide oral tactile stimulation as the tool is advanced over the tongue to deliver food.

### FIELD OF THE INVENTION

The invention relates generally to eating utensils. In particular, the invention relates to eating tools for individuals with oral sensory problems.

### BACKGROUND OF THE INVENTION

Many individuals, particularly children, have an excessive or adverse reaction to oral stimulation known as oral hypersensitivity or tactile defensiveness. Such individuals have a poor response to touch and movement on the face and inside of the mouth resulting from specific oral motor problems that occur if the muscles of the orofacial area lack adequate range of movement, strength of movement, and variety of movement. The condition affects control of movement and response to pressure and movement. Children with oral hypersensitivity or who are tactile defensive may often resist when a parent or caregiver tries to brush their teeth, wash their face, or wipe their nose. These children may also excessively grind their teeth, drool, or chew on their fingers.

Oral hypersensitivity and tactile defensiveness can result from brain injury or trauma, cerebral palsy, syndromes (e.g, Down's Syndrome), or other neurological dysfunction.

During mealtime, oral hypersensitivity can trigger a tonic bite reflex or elicit a gag reflex. Some children with hypersensitivity or tactile defensiveness do not have sensory awareness of where an object (e.g., food) is their mouth, which may result in excessive drooling. Oral hypersensitivity can also create an intense aversion to specific properties of food such as acidity, smell, spiciness, taste, and texture, which may make it difficult for an individual to move from pureed to solid foods.

A variety of techniques have been used in feeding children or individuals with these conditions. These include adjusting the individual's posture; presenting a calm environment (e.g, playing calming music); presenting verbal and/or visual cues that food will be introduced into the mouth; touching the face using firm, deep pressure; using a coated spoon; and introducing new and dissimilar properties (e.g., temperature, texture) separately so as not to overwhelm the individual.

Another common approach is to stroke the tongue, cheeks, and/or lips with an oral sensory stimulation tool, e.g., a brush, to produce an intense sensory impact prior to introducing food with a conventional spoon or other eating utensil. However, small children often resist the brush because they perceive the brush as a foreign or otherwise frightening object.

The need remains for feeding tools that provide oral tactile stimulation during delivery of food and that are readily accepted by individual with oral sensory problems.

### SUMMARY OF THE INVENTION

One aspect of the invention provides a transitional feeding tool to conventional utensil feeding for individuals with oral sensory problems. The tool provides oral tactile stimulation while delivering food to provide stimulating utensil feeding. The utensil comprises a handle and a food-carrying platform carried by the handle. The food-carrying platform has a top surface and a bottom surface extending along an axis. At least one blunt projection extends radially from the bottom surface.

In one embodiment, the projection comprises a pliable material. In another embodiment, the projection is convex dome-shaped. In yet another embodiment the projection is elongated. In one embodiment, the projection is elongated in a linear fashion. In another embodiment, the projection is elongated in a curvilinear fashion. In one embodiment, the projection is elongated along the axis of the food-carrying platform. In another embodiment, the projection is elongated traverse the axis of the food-carrying platform. In one embodiment, the food-carrying platform has at least one tine. In yet another embodiment, the food-carrying platform comprises a concave bowl. According to one aspect of the invention, the projection is adapted to contact the surface of an individual's tongue to provide oral tactile stimulation as the projection is advanced over the tongue.

Another aspect of the invention provides a method of providing oral sensory stimulating utensil feeding. The method provides an eating utensil having an axis. The eating utensil has a handle and a food-carrying platform carried by the handle. The food-carrying platform has a top surface and a bottom surface. At least one blunt projection extends radially from the bottom surface. The method provides for placing food on the platform. The utensil is introduced into an individual's mouth so that the projection contacts the individual's tongue to provide oral tactile stimulation. The utensil is advanced backward over the tongue while maintaining contact between the projection and the tongue to deliver the food.

In one embodiment, the projection comprises a pliable material. In one embodiment, the projection is elongated. In one embodiment, the projection is elongated along the axis of the utensil. In another embodiment, the projection is elongated traverse the axis of the utensil. In another embodiment, the projection is convex, dome-shaped. In one embodiment, the food-carrying platform has at least one tine. In yet another embodiment, the food-carrying platform comprises a concave bowl.

### BRIEF DESCRIPTION OF THE DRAWINGS

FIG. 1 is a top perspective view of a spoon-like feeding tool for individuals with oral sensory problems.

FIG. 2 is a bottom perspective view of the tool shown in FIG. 1.

FIG. 3 is a top plan view of the tool shown in FIG. 1.

FIG. 4 is a side plan view of the tool shown in FIG. 1.

FIG. 5 is a bottom plan view of the tool shown in FIG. 1.

FIG. 6 illustrates introduction of the tool shown in FIG. 1 into the mouth to deliver the food while providing sustained oral tactile stimulation.

FIG. 7 is a bottom plan view of an alternative embodiment of a spoon-like feeding tool for individuals with oral sensory problems in which the projections are elongated along the axis of the tool.

FIG. 8 is a bottom plan view of an alternative embodiment of a spoon-like feeding tool for individuals with oral sensory problems in which a series of projections are elongated along the axis of the tool and another series of projections are elongated traverse the axis of the tool.

FIG. 9 is a bottom plan view of an alternative embodiment of a spoon-like feeding tool for individuals with oral sensory problems in which the projections are elongated in a C-shaped curvilinear fashion.

FIG. 10 is a bottom plan view of an alternative embodiment of a spoon-like feeding tool for individuals with oral sensory problems in which C-shaped projections are arranged in an undulating or serpentine pattern.

FIG. 11 is a bottom plan view of an alternative embodiment of a spoon-like feeding tool for individuals with oral sensory problems in which the projections are elongated in a serpentine curvilinear fashion.

FIG. 12 is a bottom plan view of an alternative embodiment of a spoon-like feeding tool for individuals with oral sensory problems in which the projections are rounded, convex domes.

FIG. 13 is a bottom perspective view of the tool shown in FIG. 12.

FIG. 14 is a bottom plan view of an alternative embodiment of a spoon-like feeding tool for individuals with oral sensory problems having a series of projections elongated traverse the axis of the tool and a series of rounded, convex dome projections.

FIG. 15 is a bottom plan view of an alternative embodiment of a spoon-like feeding tool for individuals with oral sensory problems having a series of projections elongated along the axis of the tool and a series of rounded, convex dome projections.

FIG. 16 is a bottom plan view of an alternative embodiment of a spoon-like feeding tool for individuals with oral sensory problems having a series of projections elongated traverse the axis of the tool, a series of projections elongated along the axis of the tool, and a series of rounded, convex dome projections.

FIG. 17 is a bottom plan view of a fork-like feeding tool for individuals with oral sensory problems in which a series of rounded, convex dome projections extend from the bottom surface of the tines.

FIG. 18 is a side perspective view of the tool shown in FIG. 17.

FIG. 19 is a bottom plan view of an alternative embodiment of a fork-like feeding tool for individuals with oral sensory problems in which a series of rounded, convex dome projections and a series of projections elongated along the axis of the tool extend from the bottom surface of the tines and base.

FIG. 20 is a bottom plan view of an alternative embodiment of a fork-like feeding tool for individuals with oral sensory problems in which a series of rounded, convex dome projections extend from the bottom surface of the base and a series of projections elongated traverse the axis of the tool extend from the bottom surface of the tines.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention, which is defined by the claims.

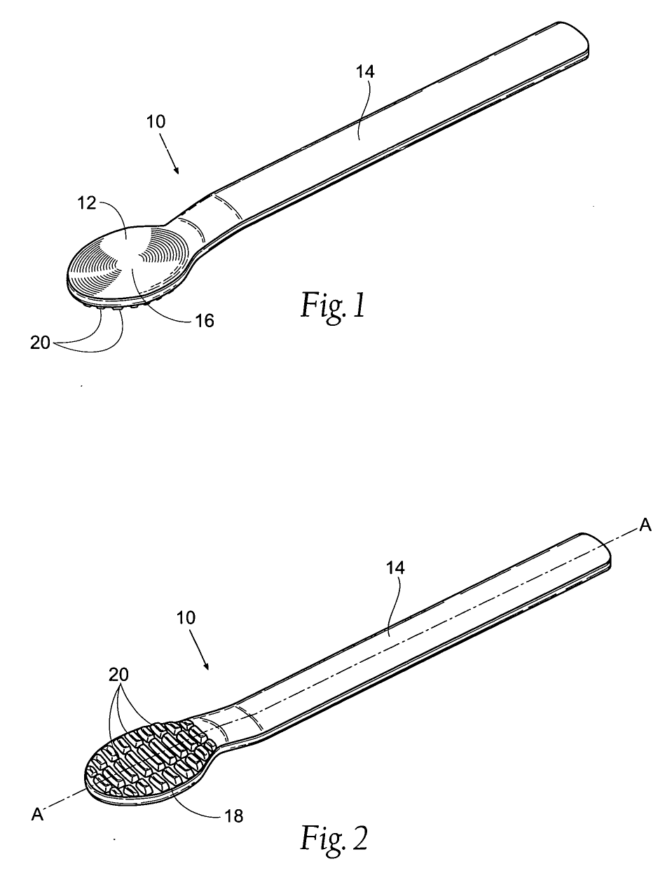

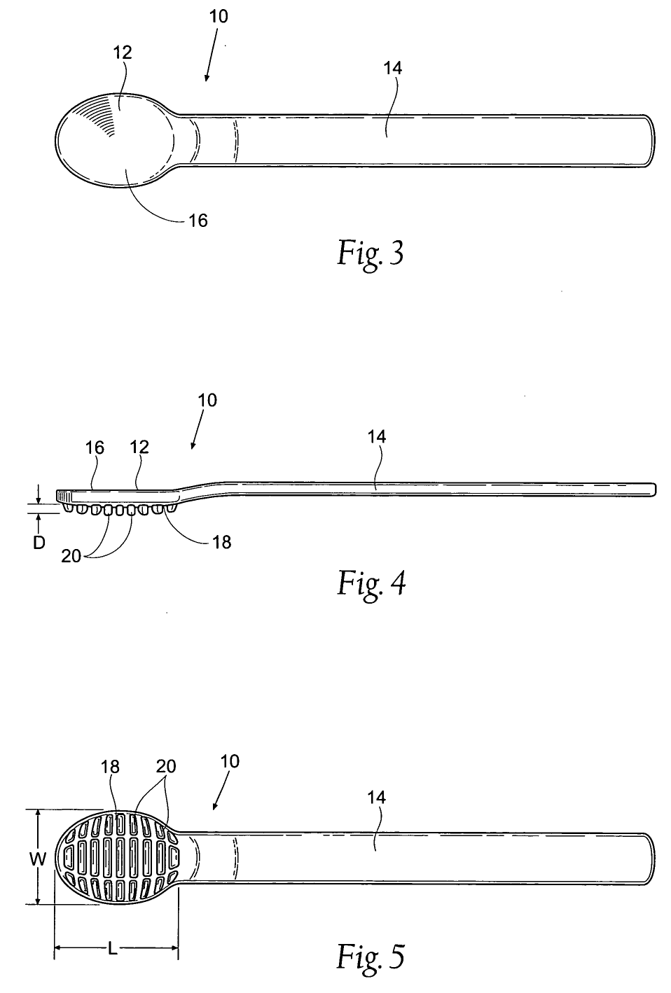

FIGS. 1-5 shows a feeding tool 10 for individuals with oral hypersensitivity or oral tactile defensiveness. The tool 10 is an oral sensory tool having the appearance and function of a conventional spoon and therefore is well-suited for use as a transitional feeding tool to conventional spoon feeding for individuals with oral sensory problems. Because the tool 10 has the appearance of a conventional spoon, it is less frightening to children than brushes or other oral stimulation tools. The tool 10 allows for oral sensory stimulation and presentation of food with a single device and in a single step, resulting in both cost and time savings.

The tool 10 includes a concave bowl 12 and an elongated handle 14 similar in appearance to a conventional spoon. The bowl 12 and handle 14 may be variously sized for comfortable placement within an individual's mouth. For example, the tool 10 may be provided in child and adult sizes.

The bowl 12 may be configured shallower than a conventional spoon bowl if desired. The shallower bowl 12 presents a smaller volume of food that is more easily managed by an individual with oral sensory problems, particularly as the individual begins to feed independently of a caretaker.

As best shown in FIGS. 1, 2, and 4, the bowl 12 is desirably offset relative to the handle 14 to easily clear the teeth 12 as the bowl is advanced into the mouth. The offset arrangement is less likely to elicit resistance or a tonic bite reflex as the tool 10 is introduced into the mouth.

The bowl 12 has a smooth upper surface 16 and a bottom surface 18 carrying a plurality of projections defining a textured surface. The projections extend from the bottom surface 18 of the bowl 12 and are not in communication with the upper surface 16 of the bowl 12. The upper surface 16 of the bowl 12 is similar in configuration to a conventional spoon, having a concave surface forming a platform to carry solids or liquids.

The projections extend radially from the bottom surface 18 of the bowl 12 and are adapted to contact the surface of the tongue to without causing pain or injury to the individual to provide sufficient oral tactile stimulation as the tool 10 is advanced forward or backward over the tongue so that food is accepted with no or minimal oral aversion.

The projections may extend the entire length L and width W of the bottom surface 18, or along only a portion of the length L and/or width W of the bottom surface 18 so as to accommodate individual anatomy and produce sufficient oral tactile stimulation (see FIG. 5). To provide sufficient oral tactile stimulation, it is preferable that the projections extend at least one-half of the length L and at least one-half of the width W of the bottom surface 18 of the bowl 12.

In the illustrated and preferred embodiment, the projections take the form of blunt, elongated teeth or ridges 20. In the illustrated embodiment, the ridges 20 are elongated in a straight or linear fashion and arranged traverse the axis A of the tool 10 in a series of columns and rows (see FIG. 2). In a representative embodiment, the depth D of the projections 20 is approximately 0.075 inch (see FIG. 4). The arrangement of the projections 20 traverse the axis A of the tool 10 provides maximum sensory input as the projections 20 are advanced over the tongue.

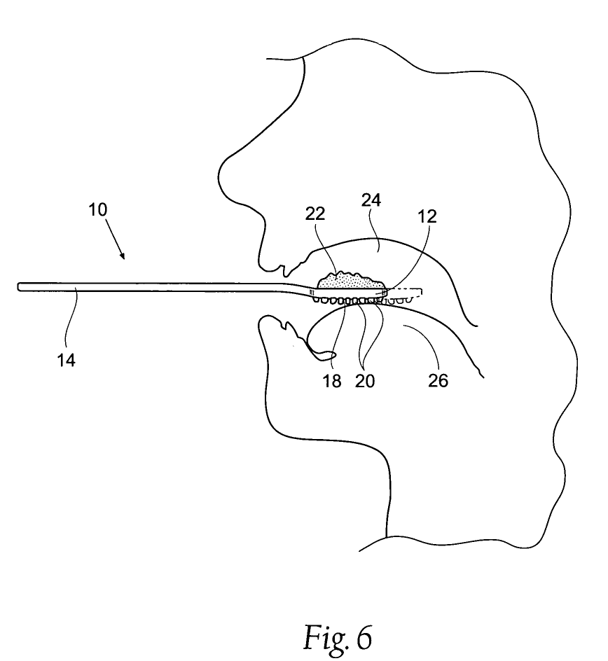

In use, as shown in FIG. 6, the individual or a caretaker places food 22 on the bowl 12 of tool 10. The tool 10 is then introduced into mouth 24, such that the projections 20 contact the surface of the tongue 26 to provide suitable oral tactile stimulation. While maintaining contact of the projections 20 with the tongue 26 to provide sustained oral tactile stimulation, the tool 10 is advanced toward the back of the mouth 24 to deliver the food 22. If desired, contact between the projections 20 and the tongue 26 may be maintained as the tool 10 is withdrawn to provide additional oral tactile stimulation.

In some cases, it may be desirable to first introduce the tool 10 without food 22 so that the individual becomes comfortable with the introduction of the tool 10 into the mouth 24. In such cases, the tool 10 can be introduced into mouth 24, such that the projections 20 contact the tongue 26 to provide suitable oral tactile stimulation, and the tool 10 is advanced forward toward the back of the mouth 24 or forward and back over the tongue 26 in a series of forward and aft movements. Once the individual accepts introduction of the tool 10 into the mouth 24 without resistance, the tool 10 is removed. The caretaker then places food 22 on the tool 10 and delivers the food 22 while providing sustained oral tactile stimulation, as previously described.

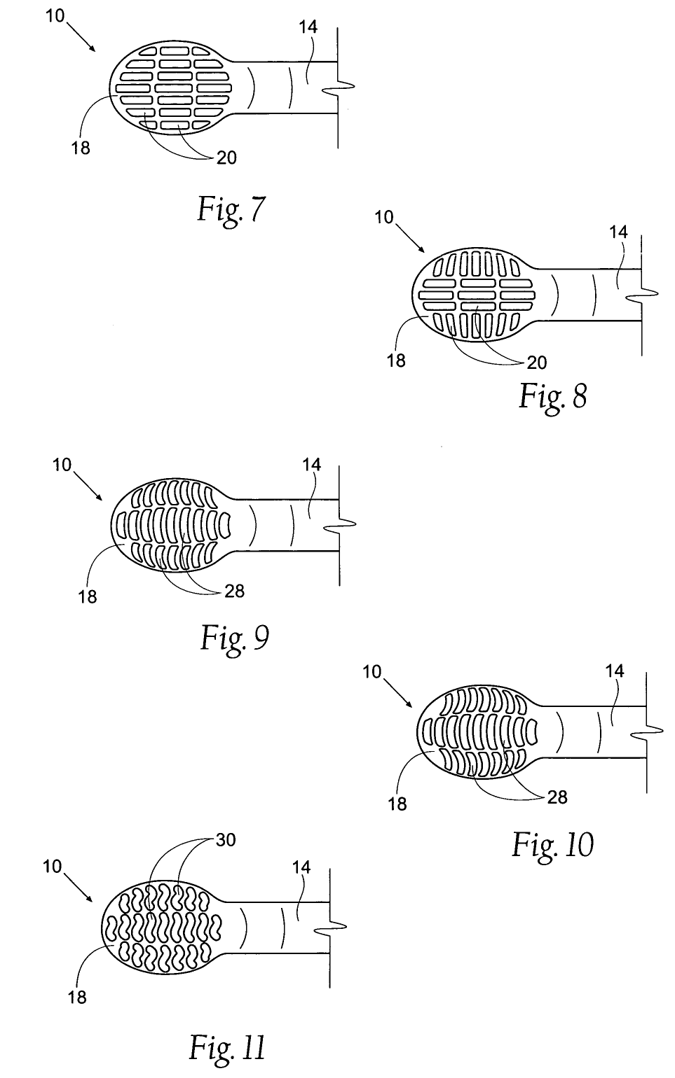

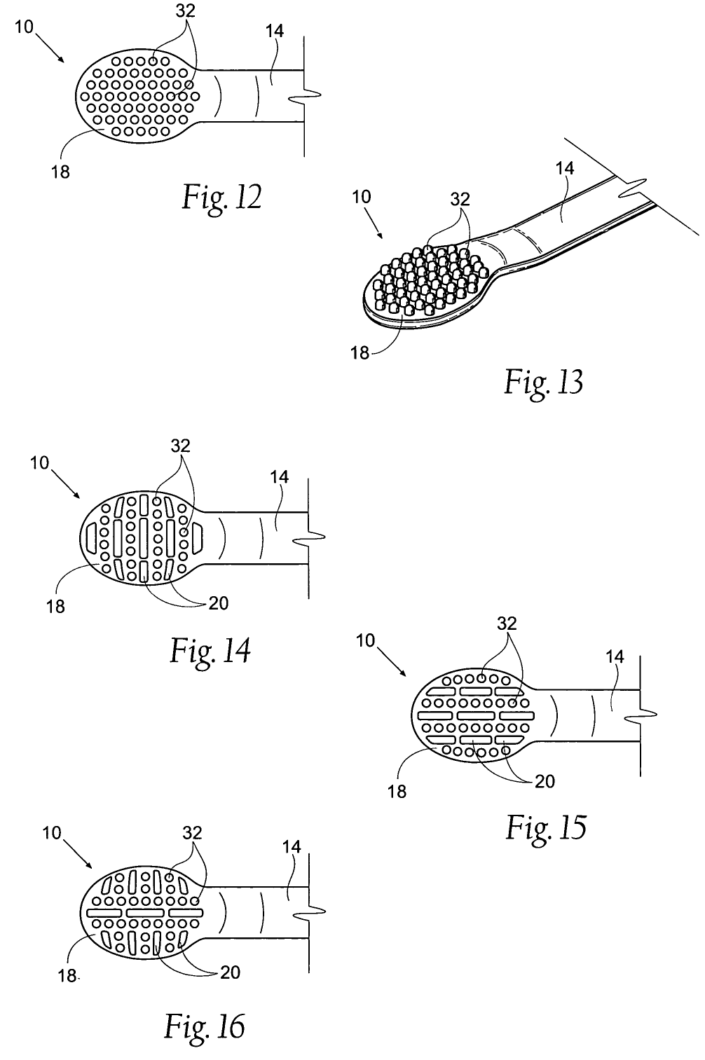

It is contemplated that the size, shape, depth, and placement of the projections 20 may vary to accommodate individual anatomy and to provide suitable oral tactile stimulation so that food is accepted with no or minimal oral aversion. In another alternative embodiment, illustrated in FIG. 7, the projections 20 are elongated along the axis A of the tool 10. Another alternative embodiment is shown in FIG. 8, in which a series of projections 20 are elongated along the axis A of the tool 10 and another series of projections 20 are elongated traverse the axis A of the tool 10. Alternatively, the projections 20 may take the form of an elongated C-shaped curvilinear teeth or ridges 28, as shown in FIG. 9. As seen in FIG. 10, a series of ridges 28 may be arranged end-to-end in alternating directions to provide a serpentine or undulating pattern. FIG. 11 shows another embodiment in which the projections take the form of S-shaped teeth or ridges 30. In yet another alternative embodiment, the projections take the form of blunt, rounded or convex domes 32, as shown in FIGS. 12 and 13.

It is apparent that projections of varying sizes or configuration may be arranged in an infinite number of patterns. By way of illustration and not limitation, FIGS. 14-16 show various patterns that can be formed by combining a plurality of elongated, linear projections 20 and a plurality of rounded, convex dome projections 32. In one embodiment, a series of rounded, convex dome projections 32 are combined with a series of projections 32 elongated traverse the axis of the tool 10, as seen in FIG. 14. FIG. 15 shows an embodiment in which a series of rounded, convex dome projections 32 are combined with a series of projections 20 elongated along the axis of the tool 10. In another embodiment, illustrated in FIG. 16, a series of rounded, convex dome projections 32 are combined with a series of projections 20 elongated traverse to the axis of the tool 10 and a series of projections elongated along the axis of the tool 10.

Conventional metal feeding utensils often cause an adverse reaction or meet resistance from individuals with oral sensory problems. Therefore, it is preferable that the tool 10, or at least the bowl 10 and projections 20 or 28 or 30 or 32 (i.e., the components contacting oral surfaces), be formed of a material, e.g., plastic, that is likely to be readily accepted by such individuals with no or minimal oral aversion. The tool 10 is also desirably formed from a material that is easily washable for reuse.

The tool 10 may be injection-molded by conventional techniques from any suitable plastic, e.g., ABS, as a unitary piece. If desired, the projections 20 or 28 or 30 or 32 or the entire bowl portion 12 can be overmolded with a pliable material, e.g., rubber. In many cases, the soft, pliable surface may be more readily accepted by an individual with oral sensory problems. Alternatively, the entire tool 10 can be overmoldered with the pliable material.

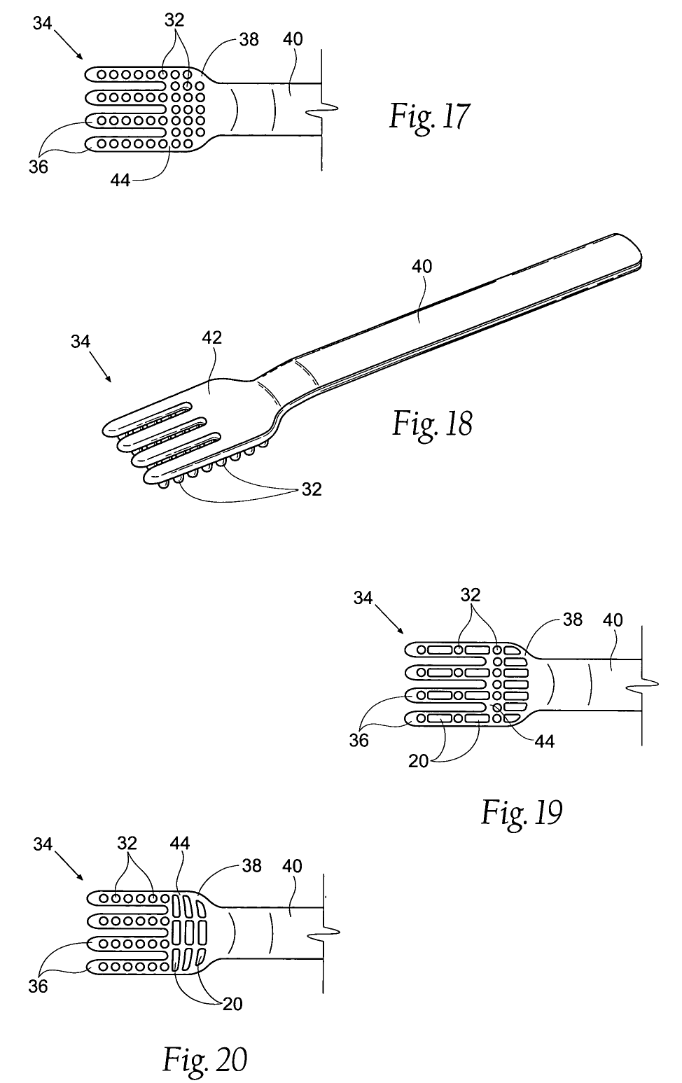

FIGS. 17 and 18 illustrate another feeding tool 34 for individuals with oral hypersensitivity or oral tactile defensiveness. The tool 34 is an oral sensory tool having the appearance and function of a fork. The tool 34 includes a series of tines 36 extending from a base 38 and an elongated handle 40 similar in appearance to a conventional fork. The tool 34 may be variously sized for comfortable placement within an individual's mouth. For example, the tool 34 may be provided in child and adult sizes.

The tines 36 and base 38 have a smooth top surface 42 that serves as a platform for carrying food similar to a conventional fork. The bottom surface 44 includes a series of projections defining a textured bottom surface. The projections are sized and configured to contact the tongue to provide oral tactile stimulation, as previously described. The projections may take a variety of forms, including elongated ridges 20, curvilinear ridges 28 or 30, or rounded, convex dome projections 32 as previously described.

It is contemplated that the size, shape, depth, and placement of the projections 20 or 28 or 30 or 32 may vary to accommodate individual anatomy and to provide suitable oral tactile stimulation so that food is accepted with no or minimal oral aversion. It is to be understood that the projections 20 or 28 or 30 or 32 may extend along the entire bottom surface 44 of the tool 34 or any portion of the bottom surface 44. That is, the projections 20 or 28 or 30 or 32 may extend along the entire bottom surface 44 or a portion of the bottom surface 44 of one or more tines 36. The projections 20 or 28 or 30 or 32 may also extend along the bottom surface 44 of the base 38 or a portion of the base 38.

In the embodiment illustrated in FIGS. 17 and 18, the projections take the form of rounded, convex dome projections 32 that extend from the bottom surface 44 of both the tines 36 and the base 38.

By way of illustration and not limitation, FIGS. 19 and 20 illustrate elongated ridge projections 20 and rounded, convex dome projections 32 combined in various different patterns. For example, as shown in FIG. 19, a series of convex dome projections 32 and series of elongated ridges 20 may extend from the bottom surface 44 of both the tines 36 and the base 38. Alternatively, as shown in FIG. 20, a series of convex dome projections 32 (each extending from a single tine 36) may extend from the bottom surface 44 of the tines 36 and a series of elongated ridges 20 may extend from the bottom surface 44 of the base 38 elongated traverse the axis of the tool 34. It is apparent that projections of varying sizes or configuration may be arranged in an infinite number of patterns.

The tool 34 is desirably formed from a material that is easily washable for reuse. The tool 34 may be injection-molded from any suitable plastic, as previously described. If desired, the tines 36 and base 38, including projections 20 or 28 or 30 or 32 can be overmolded with a pliable material, as also previously described. Alternatively, the entire tool 34 can be overmolded with the pliable material.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1-17. (canceled)

18. An eating utensil comprising
a handle,
a food-carrying platform carried by the handle and having a top surface and a bottom surface, the food-carrying platform having at least one tine and extending along an axis, and
at least at least one convex, dome-shaped blunt extending radially from at least one of the top surface and the bottom surface.

19-25. (canceled)

26. An eating utensil as in claim 18
wherein the projection extends radially from the bottom surface.

27-32. (canceled)

33. An eating utensil as in claim 18
wherein the projection comprises a pliable material.

34. An eating utensil comprising
a handle,
a food-carrying platform carried by the handle and having a top surface and a bottom surface, the food-carrying platform having at least one tine and extending along an axis, and
at least one blunt projection elongated along the axis of the food-carrying platform and extending radially from at least one of the top surface and the bottom surface.

35. An eating utensil as in claim 34
wherein the projection comprises a pliable material.

36. An eating utensil as in claim 34
wherein the projection is linear.

37. An eating utensil as in claim 34
wherein the projection is curvilinear.

38. An eating utensil as in claim 34
wherein the projection extends radially from the bottom surface.

39. An eating utensil comprising
a handle,
a food-carrying platform carried by the handle and having a top surface and a bottom surface, the food-carrying platform having at least one tine and extending along an axis, and
at least one blunt projection elongated traverse the axis of the food-carrying platform and extending radially from at least one of the top surface and the bottom surface.

40. An eating utensil as in claim 39
wherein the projection comprises a pliable material.

41. An eating utensil as in claim 39
wherein the projection is linear.

42. An eating utensil as in claim 39
wherein the projection is curvilinear.

43. An eating utensil as in claim 39
wherein the projection extends radially from the bottom surface.

44. An eating utensil comprising
a handle,
a food-carrying platform carried by the handle and having a top surface and a bottom surface, the food-carrying platform comprising a concave bowl and extending along an axis, and
at least one blunt projection elongated along the axis of the food-carrying platform, the projection having a generally smooth bottom surface and extending radially from at least one of the top surface and the bottom surface.

45. An eating utensil as in claim 44
wherein the projection comprises a pliable material.

46. An eating utensil as in claim 44
wherein the projection is linear.

47. An eating utensil as in claim 44
wherein the projection is curvilinear.

48. An eating utensil as in claim 44
wherein the projection extends radially from the bottom surface.

49. An eating utensil comprising
a handle,
a food-carrying platform carried by the handle and having a top surface and a bottom surface, the food-carrying platform comprising a concave bowl and extending along an axis, and
at least one blunt projection elongated traverse the axis of the food-carrying platform, the projection having a generally smooth bottom surface and extending radially from at least one of the top surface and the bottom surface.

50. An eating utensil as in claim 49
wherein the projection comprises a pliable material.

51. An eating utensil as in claim 49
wherein the projection is linear.

52. An eating utensil as in claim 49
wherein the projection is curvilinear.

53. An eating utensil as in claim 49
wherein the projection extends radially from the bottom surface.

54. An eating utensil comprising
a handle,
a food-carrying platform carried by the handle and having a top surface and a bottom surface, the food-carrying platform comprising a concave bowl and extending along an axis, and
at least one convex, dome shaped blunt projection extending radially from at least one of the top surface and the bottom surface.

55. An eating utensil as in claim 54
wherein the projection comprises a pliable material.

56. An eating utensil as in claim 54
wherein the projection extends radially from the bottom surface.

57. An eating utensil comprising
a handle,
a food-carrying platform carried by the handle and having a top surface and a bottom surface, the food-carrying platform comprising a concave bowl and extending along an axis, and
at least one blunt projection elongated along the axis of the food-carrying platform and extending radially from the bottom surface.

58. An eating utensil as in claim 57
wherein the projection comprises a pliable material.

59. An eating utensil as in claim 57
wherein the projection is linear.

60. An eating utensil as in claim 57
wherein the projection is curvilinear.

61. An eating utensil comprising
a handle,
a food-carrying platform carried by the handle and having a top surface and a bottom surface, the food-carrying platform comprising a concave bowl and extending along an axis, and
at least one blunt projection elongated traverse the axis of the food-carrying platform and extending radially from the bottom surface.

62. An eating utensil as in claim 61
wherein the projection comprises a pliable material.

63. An eating utensil as in claim 61
wherein the projection is linear.

64. An eating utensil as in claim 61
wherein the projection is curvilinear.

65. An eating utensil comprising
a handle,
a food-carrying platform carried by the handle and having a top surface and a bottom surface, the food-carrying platform the food-carrying platform comprising a concave bowl and extending along an axis, and
at least one blunt projection comprising a pliable material overmolded unto the platform and extending radially from at least one of the top surface and the bottom surface.

66. An eating utensil comprising
a handle;
a food-carrying platform carried by the handle and having a top surface and a bottom surface, the food-carrying platform having at least one tine and extending along an axis, and
at least one blunt projection comprising a pliable material overmolded unto the platform and extending radially from at least one of the top surface and the bottom surface.
